(19) United States
(12) Patent Application Publication
(10) Pub. No.: US 2012/0192964 A1
(43) Pub. Date: Aug. 2, 2012

(54) FLUID CONTROL APPARATUS

(75) Inventors: Izuru SHIKATA, Osaka-shi (JP); Tsuneo Yoshida, Osaka-shi (JP); Shinya Nojima, Osaka-shi (JP)

(73) Assignee: FUJIKIN INCORPORATED, Osaka-shi (JP)

(21) Appl. No.: 13/360,863

(22) Filed: Jan. 30, 2012

(30) Foreign Application Priority Data
Jan. 31, 2011 (JP) 2011017409

(51) Int. Cl. F16L 3/00

(52) U.S. Cl. 137/343

(57) ABSTRACT

There is provided a fluid control apparatus with which assembling time is shortened by easily positioning the line support members, and the height of the portion supporting the fluid control devices is reduced. Each supporting frame member 11 and 12 is provided with threaded holes at required intervals. An bent-shaped first mounting portion 22 of a line support member 3 is overlapped with an outer surface of the first supporting frame member 11 and a male-threaded member 10 is screwed into one of the threaded holes of the first supporting frame member 11 from an outer side of the first mounting portion 22 whereby each of the line support members 3 is secured to the first supporting frame member 11.

### BACKGROUND OF THE INVENTION

1. Field of the Invention

The present invention relates to a fluid control apparatus for use in a semiconductor fabrication device and the like and more particularly relates to a fluid control apparatus constituted by integrating a plurality of fluid control devices.

2. Background Art

Fluid control apparatuses for use in semiconductor fabrication devices have been increasingly integrated, by installing, in parallel on a base member, a plurality of lines each formed by a plurality of fluid control devices placed in series and connected to one another without interposing pipes and joints thereamong. The integrated fluid control apparatus is often installed within a housing such that the base member is placed vertically. Japanese Patent Laid-Open No. 2009-204090 discloses, as a fluid control apparatus as described above, a fluid control apparatus having a plurality of movable rails and a pair of fixed rails, in which a plurality of fluid control devices are mounted to one movable rail (line support member) to form a line, and each of the movable rails of the lines is slidably mounted to the fixed rails (base members) extending in a direction orthogonal to the movable rails.

The conventional fluid control apparatus as described above offers an advantage that, by preliminarily assembling a plurality of fluid control devices onto the movable rail, assembling work within the housing only requires mounting the movable rails to the fixed rails, thereby facilitating line addition or line alteration.

The conventional fluid control apparatus, however, has had a problem that in positioning and fastening the movable rails because positioning and fastening of the movable rails have been performed simultaneously, mounting of the movable rails (line support members) has been time consuming.

The conventional fluid control apparatus further has had another problem that due to the structure that the end portion of the movable rail is overlapped with the fixed rail, the height of the portion supporting the fluid control device is a height of the movable rail (line support member) plus the fixed rail (base member), and the above-mentioned height plus the height of the fluid control device is the height of the fluid control apparatus, which is tall, thereby requiring a large space (a large housing) for enclosing the fluid control apparatus.

It is an object of the present invention to provide a fluid control apparatus that enables shortened assembling time by easy positioning of the line support member, and reduced height of the portion supporting the fluid control device.

### SUMMARY OF THE INVENTION

The present invention provides a fluid control apparatus having a plurality of lines, each of the lines constituted by a plurality of fluid control devices mounted to a line support member, the line support members parallel to one another being detachably mounted to a base member, wherein the base member, having a rectangular frame-like shape, is constituted by a first supporting frame member, a second supporting frame member parallel to the first supporting frame member, a first connecting frame member orthogonal to the first and second supporting frame members, and a second connecting frame member orthogonal to the first and second supporting frame members; each of the frame members being provided with threaded holes at required intervals depending on each frame member; each of the line support members including a flat-plate shaped device placing portion, and first and second mounting portions provided at both ends of the device placing portion; each of the first and second mounting portions having a through hole; the first mounting portion being bent-shaped; the threaded holes of the first supporting frame member being oriented in a direction from an outer surface of the first supporting frame member toward an inner surface thereof; and each of the line support members being secured to the first supporting frame member such that the first mounting portion is overlapped with the outer surface of the first supporting frame member and a male-threaded member is screwed into one of the threaded holes of the first supporting frame member from an outer side of the first mounting portion.

The present invention also provide a fluid control apparatus wherein the second mounting portion is bent-shaped, the threaded holes of the second supporting frame member are oriented in a direction from an outer surface of the second supporting frame member toward an inner surface thereof, and each of the line support members is secured to the second supporting frame member such that the second mounting portion is overlapped with the outer surface of the second supporting frame member and a male-threaded member is screwed into one of the threaded holes of the second supporting frame member corresponding to the screwed threaded hole of the first supporting frame member from an outer side of the second mounting portion (a first embodiment). Further, the present invention also provides a fluid control apparatus wherein the second mounting portion is flat-plate shaped and flush with the device placing portion, the threaded holes of the second supporting frame member are oriented in a direction from a front side of the second supporting frame member toward a back side thereof, and each of the line support members is secured to the second supporting frame member such that the second mounting portion is overlapped with the front side of the second supporting frame member and a male-threaded member is screwed into one of the threaded holes of the second supporting frame member corresponding to the screwed threaded hole of the first supporting frame member from a front side of the second mounting portion (a second embodiment).

As fluid control devices, on-off valves (valves that shuts off and opens flow channels), pressure-reducing valves, pressure indicator, flow-rate regulators (massflow controllers), and the like are used.

A line is assembled, for example, by mounting a plurality of block-shaped joint members forming a lower stage to the line support member by male-threaded members, and by mounting a plurality of fluid control devices forming an upper stage to the joint members so as to straddle the adjacent joint members by male-threaded members from above. With this structure, the fluid control device at the upper stage may be removed upward independently by removing the male-threaded members screwed from above. The line structure is not limited by one consisting of the lower stage and the upper stage, but may employ various kinds of structures.

The fluid control apparatus may be installed with the base member having a rectangular frame-like shape being placed vertically (Y direction), and also may be installed with the base member having the rectangular frame-like shape being placed horizontally (X direction, Y direction). When the fluid control apparatus is installed vertically, the first supporting frame member may be placed above, with the second supporting frame member being placed below and the line support members being placed vertically in parallel, whereas the first supporting frame member also may be placed on the either side of the right and left sides, with the second supporting frame member being place on the other side and the line support members being placed horizontally in parallel.

Each of the line support members is made of, for example, sheet metal folded into a U-shaped configuration to form a main body portion. Each of the supporting frame members is a flat bar made of metal, for example stainless steel. Each of the connecting frame members generally has the similar shape as the line support members.

To assemble the fluid control apparatus, first, the first mounting portion is overlapped with the outer surface of the first supporting frame member placed on the upper side whereby line support member is supported by the first supporting frame member, and then, the second mounting portion is overlapped with the second supporting frame member. In this state, a male-threaded member is screwed into the threaded hole of the first supporting frame member from the outer side of the first mounting portion to secure the line support member to the first supporting frame member whereas another male-threaded member is screwed into the threaded hole of the second supporting frame member from the outer side of the second mounting portion to secure the line support member to the second supporting frame member.

With this structure, because the line support member is supported by the first supporting frame member due to the force of its own weight, the burden of the worker with respect to weight is reduced and the required amount of effort and time for the work is also reduced.

The through hole formed in the bent-shaped mounting portion is generally a circular hole, and may have a size to be preliminarily fitted with the male-threaded member to prevent disengagement of the male-threaded member and also may be larger than the above-mentioned size. The through hole formed in the bent-shaped mounting portion may be a closed hole, or may be opened at the end face.

The through hole of the flat-plate shaped second mounting portion, along with the through hole provided in the bent-shaped mounting portion, may be a closed circular hole or may be a hole opened at the end face, but preferably it is opened at the end face. With this structure, the through hole opened at the end face and provided in the second mounting portion of the line support member may be fitted with the male-threaded member in a state where the male-threaded member is preliminarily secured to the second supporting frame member, thereby reducing the required amount of labor for tightening work of the male-threaded member.

Because the through hole of the flat-plate shaped second mounting portion is opened at the end face, the structure is easily obtained that in a state where the fluid control apparatus is installed with the base member disposed vertically, the first supporting frame member is placed at either one side of right and left sides, the second supporting frame member is placed at the other side, the line support members are arranged in horizontally parallel to one another, and the male-threaded member is temporarily screwed into the second supporting frame member, the through hole of the second mounting portion opened at the end face is fitted with the male-threaded member.

With this structure, even in the case where the fluid control apparatus in which the supporting frame members are arranged vertically in parallel is installed, falling of the line support member due to the force of its own weight may be prevented at the time of mounting of the line support members, which offers greater versatility with respect to the installation location and installation method of the fluid control apparatus.

In the case where the fluid control apparatus in which the supporting frame members are arranged vertically in parallel is installed, adjacent line support members arranged one above the other are sometimes connected by a connecting member, and at least one of the line support members, on a lower side thereof, is sometimes supported by a dummy member mounted to both of the supporting frame members.

The connecting member is, for example, made of metal plate material and is mounted to the corresponding line support members by means of bolts (male-threaded members).

As a dummy member, a line support member on which no fluid control device is disposed may be used. Moreover, the dummy member may be a short member, having a shape of part of the line support member, and mounted to either one of the supporting frame members.

Using the connecting member or the dummy member prevents tilting of the heavyweight line support member to which the fluid control devices have been mounted whereby a problem caused at the time of arranging the supporting frame members vertically in parallel (a possibility that the line support member may be tilted due to the force of its own weight) is overcome.

In the present specification, the term “front view” refers to a state in which the line support member to which the fluid control devices have been mounted is mounted on the base member secured to the surface of the wall, with the fluid control devices being placed at the front. The front side and the back side are based on the above-mentioned state (FIG. 1).

According to the fluid control apparatus of the present invention, the base member, having a rectangular frame-like shape, is constituted by a first supporting frame member, a second supporting frame member, a first connecting frame member orthogonal to the first and second supporting frame members, and a second connecting frame member orthogonal to the first and second supporting frame members; each of the frame members being provided with threaded holes at required intervals depending on each frame member; each of the line support members including a flat-plate shaped device placing portion, and first and second mounting portions provided at both ends of the device placing portion; each of the first and second mounting portions having a through hole; the first mounting portion being bent-shaped; the threaded holes of the first supporting frame member being oriented in a direction from an outer surface of the first supporting frame member toward an inner surface thereof; and each of the line support members being secured to the first supporting frame member such that the first mounting portion is overlapped with the outer surface of the first supporting frame member and a male-threaded member is screwed into one of the threaded holes of the first supporting frame member from an outer side of the first mounting portion. Therefore, positioning of each of the line support members only requires matching the through hole of the first mounting portion with the threaded hole of the first supporting frame member, which enables simple and easy securing work and shortened assembling time. Moreover, because the first mounting portion of each of the line support members is overlapped with the outer surface of the first supporting frame member, the height of the portion supporting the fluid control devices may be reduced.

### BRIEF DESCRIPTION OF THE DRAWINGS

FIG. 1 is a front view showing a first embodiment of a fluid control apparatus according to the present invention;

FIG. 2, including FIGS. 2A and 2B, shows a line portion of the first embodiment of the fluid control apparatus according to the present invention, in which FIG. 2A is an enlarged, partially cutout front view and FIG. 2B is an enlarged, partially cutout front view showing a line support member only;

FIG. 3 is an enlarged, partially cutout side view showing a line portion of the first embodiment of the fluid control apparatus according to the present invention;

FIG. 4, including FIGS. 4A and 4B, shows a first supporting frame member used in the first embodiment of the fluid control apparatus according to the present invention, in which FIG. 4A is a partially cutout front view, and FIG. 4B is a partially cutout side view, and FIG. 4C is a partially cutout plan view;

FIG. 5 is an enlarged, partially cutout perspective view showing the line support member used in the first embodiment of the fluid control apparatus according to the present invention;

FIG. 6 is a front view showing a second embodiment of the fluid control apparatus according to the present invention;

FIG. 7, including FIGS. 7A and 7B, shows a line portion of the second embodiment of the fluid control apparatus according to the present invention, in which FIG. 7A is an enlarged, partially cutout front view and FIG. 7B is an enlarged, partially cutout front view showing the line support member only;

FIG. 8 is an enlarged, partially cutout side view showing a line portion of the second embodiment of the fluid control apparatus according to the present invention;

FIG. 9, including FIGS. 9A, 9B, and 9C, shows a second supporting frame member used in the second embodiment of the fluid control apparatus according to the present invention, in which FIG. 9A is a partially cutout front view, FIG. 9B is a partially cutout side view, and FIG. 9C is a partially cutout plan view;

FIG. 10 is a front view showing a third embodiment of the fluid control apparatus according to the present invention; and

FIG. 11 is a front view showing a fourth embodiment of the fluid control apparatus according to the present invention.

### DETAILED DESCRIPTION OF THE PREFERRED EMBODIMENTS

Hereinafter, embodiments of the present invention will be described, with reference to the drawings.

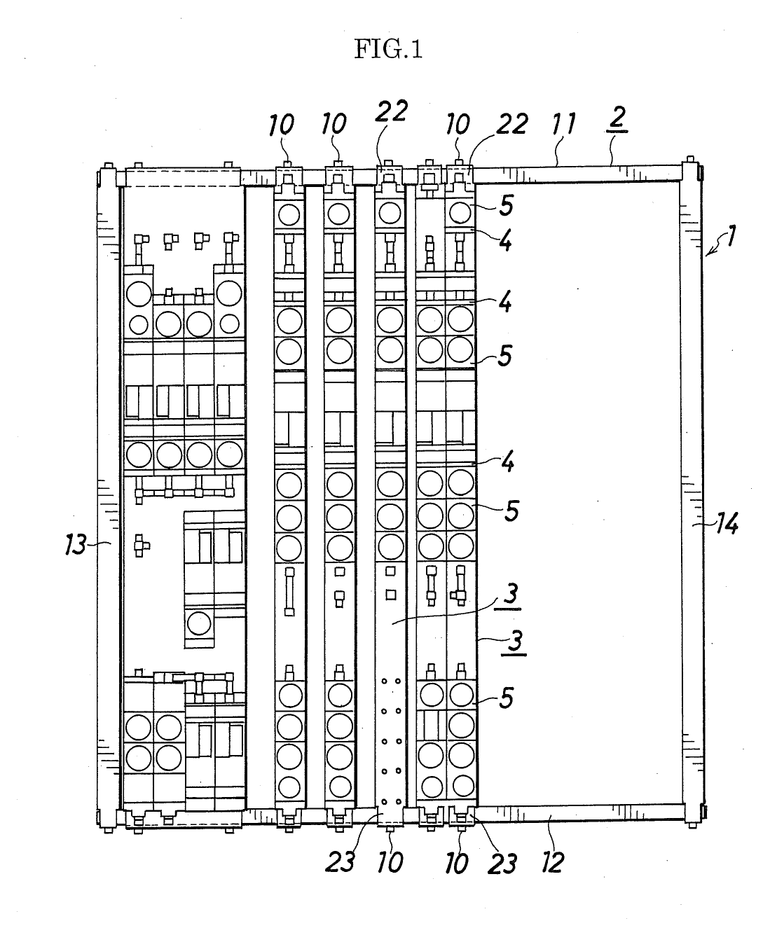

In the following description, the terms “upper,” “lower,” “right, ” and “left” refer to “upper, ” “lower, ” “right, ” and “left” regarding FIG. 1, and “front (front side)” and “rear (back side)” refer to the front (front side) for the obverse side of the paper of FIG. 1, and the rear (back side) for the reverse side of the paper of FIG. 1. This installation state is a typical installation state of the fluid control apparatus. But the installation state of the fluid control apparatus of the present invention is not limited by this installation state, and the fluid control apparatus may be used horizontally (X and Z directions) and vertically (Y direction). In such cases, the terms “upper,” “lower,” “right,” and “left” is not specifically limited.

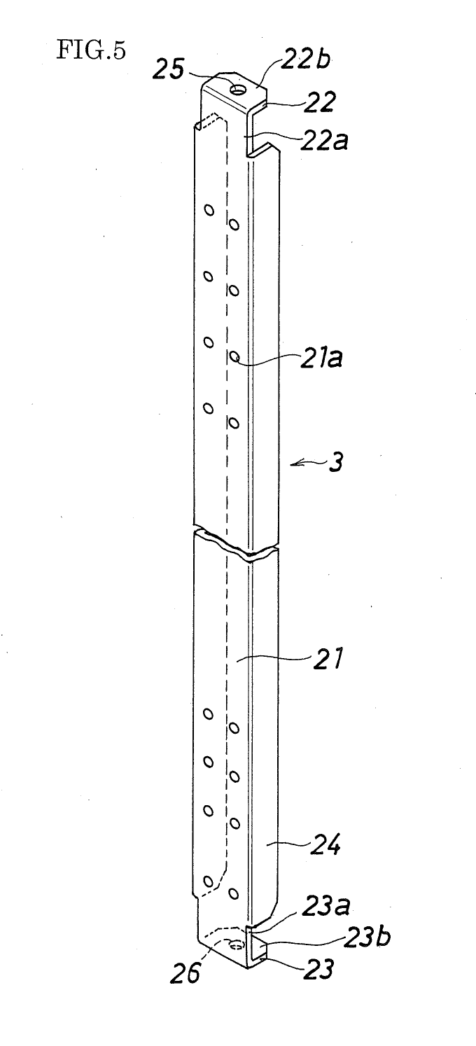

FIGS. 1 to 5 illustrate a fluid control apparatus according to a first embodiment of the present invention.

A fluid control apparatus 1, as illustrated in FIGS. 1 to 3, has a plurality of lines, each of which is formed by mounting a plurality of block-shaped joint members 4, forming a lower stage, to the line support member 3, and by mounting a plurality of fluid control devices 5, forming an upper stage, to the joint members 4 so as to straddle the adjacent joint members 4, and line support members 3 are detachably mounted to a base member 2 so as to be parallel to one another. Each of the fluid control devices 5 has a function different from one another, but since they are known, they are collectively given the same reference numeral 5 and will not be described separately.

The base member 2 is secured, for example, to a vertical wall surface of the housing. For the line alternation or addition, the line support member 3 to which the joint members 4 and the fluid control devices 5 have been assembled is to be attached and/or detached.

The base member 2, having a rectangular frame-like shape, is constituted by a first supporting frame member 11 placed on the upper side, a second supporting frame member 12 placed on the lower side, a first connecting frame member 13 placed on the left side and orthogonal to the supporting frame members 11 and 12, and a second connecting frame member 14 placed on the right side and orthogonal to the supporting frame members 11 and 12.

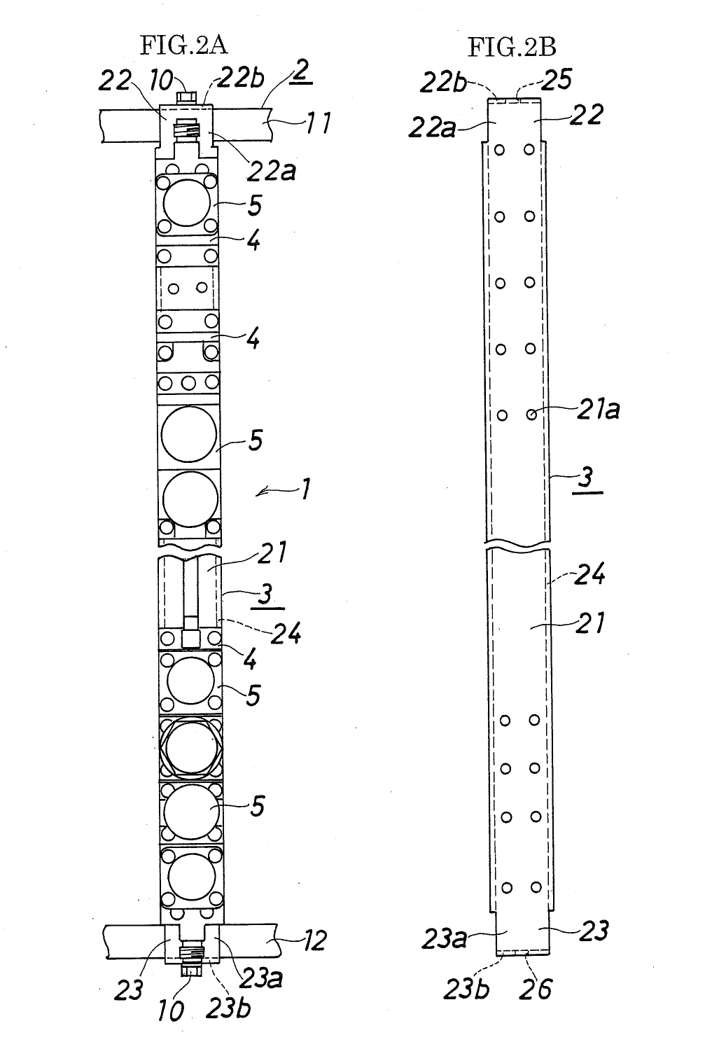

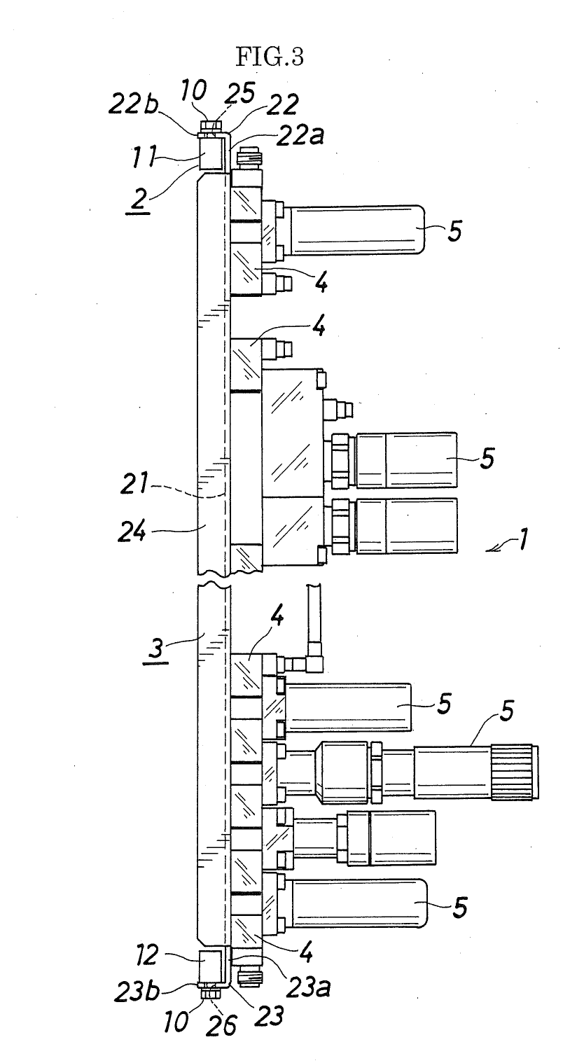

As illustrated in FIGS. 2 and 3, each of the fluid control devices 5 is secured to the corresponding joint members 4 by male-threaded members 6 from the front side. Each of the joint members 4 is secured to the line support member 3 by (not illustrated) male-threaded members from the front side.

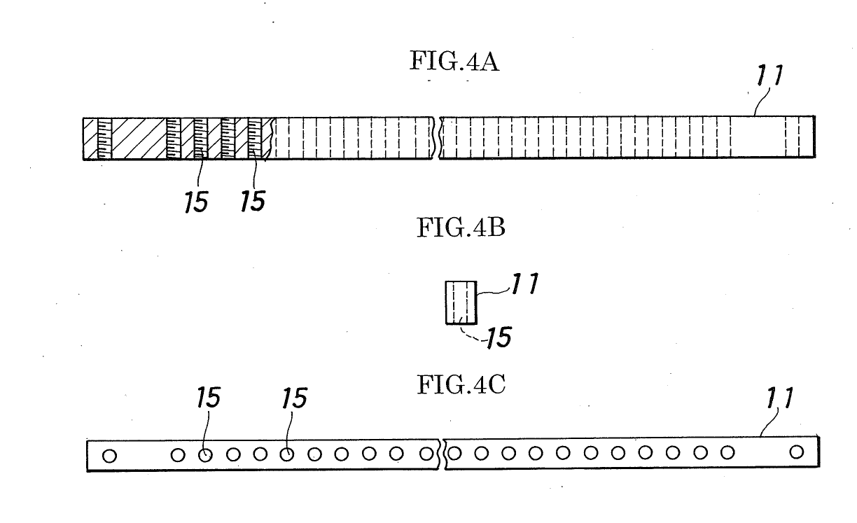

Each of the supporting frame members 11 and 12 is a flat bar made of stainless steel. As illustrated in FIG. 4, the first supporting frame member 11 is provided, at required intervals, with a plurality of threaded holes 15 penetrating vertically through the first supporting frame member, which are oriented in a direction from the upper surface (outer surface) of the first supporting frame member 11 toward the lower surface (inner surface) thereof. The second supporting frame member 12 has the same shape as the first supporting frame member 11. Although not illustrated, the second supporting frame member 12 is provided, at required intervals, with a plurality of threaded holes penetrating vertically through the second supporting frame member 12, which are oriented in a direction from the lower surface (outer surface) of the second supporting frame member 12 toward the upper surface (inner surface) thereof.

The threaded holes 15 of the first supporting frame member 11 and the second supporting frame member 12 are formed at smaller intervals than the pitch of the line support member 3 to be placed. Of the plurality of threaded holes 15, every second threaded hole 15, or every third threaded hole 15, for example, may be used to secure the line support member 3.

The line support member 3 is formed as an integrated part by bending sheet metal. As illustrated in FIGS. 2, 3, and 5, the line support member 3 is constituted by a flat-plate shaped device placing portion 21, upper and lower mounting portions 22 and 23 disposed at both ends of the device placing portion 21 and formed by folding upper and lower extended portions from the device placing portion 21, and reinforcing portions 24 extending from both edges of the device placing portion 21.

The device placing portion 21 is provided at required intervals with threaded holes 21a for mounting joint members 4.

The mounting portions 22 and 23 of the line support member 3, being approximately L-shaped, are constituted by flat-plate shaped flat-plate parts 22a and 23a flush with the device placing portion 21, and right-angled parts 22b and 23b extending from the flat-plate parts 22a and 23a at a right angle, respectively. The right-angled parts 22b and 23b are respectively provided with through holes 25 and 26 penetrating through the right-angled parts 22b and 23b vertically. The reinforcing portions 24 are formed not to fall upon the flat-plate parts 22a and 23a of the mounting portions 22 and 23. Each of the end faces of the reinforcing portions 24 and each of the right-angled parts 22b and 23b of the mounting portions 22 and 23 are designed to sandwich each of the supporting frame members 11 and 12.

In FIG. 1, line support members 3 having two kinds of widths (wide and narrow) are used (since they have the same shape except for the width, they are collectively given the same reference numeral 3). A space for installing additional lines is saved on the right side of the base member 2.

As illustrated in FIGS. 1 to 3, right-angled part 22b of the upper mounting portion 22 of the line support member 3 is overlapped with the upper surface (outer surface) of the first supporting frame member 11 and a male-threaded member 10 is screwed into one of the threaded holes of the first supporting frame member 11 through the through hole 25 from above (outer side) of the right-angled part 22b of the upper mounting portion 22 whereby the upper end of the line support member 3 is secured to the first supporting frame member 11, whereas the right-angled part 23b of the lower mounting portion 23 is overlapped with the lower surface (outer surface) of the second supporting frame member 12 and another male-threaded member 10 is screwed into one of the threaded holes of the second supporting frame member 12 corresponding to the screwed threaded hole of the first supporting frame member 11 through the through hole 26 from below (outer side) of the right-angled part 23b of the lower mounting portion 23 whereby the lower end of the line support member 3 is secured to the second supporting frame member 12.

In securing line support members 3 as described above, positioning of each of the line support members 3 only requires matching through holes 25 and 26 of the mounting portions 22 and 23 with threaded holes 15 of respective supporting frame members 11 and 12, which enables simple and easy securing work and shortened assembling time. Moreover, because right-angled parts 22b and 23b of the bent-shaped mounting portions 22 and 23 of each of the line support members 3 is overlapped with the outer surface of each of the supporting frame members 11 and 12, the height of the base member 2 (each of the supporting frame members 11 and 12) plus the line support member 3 is not a height of the base member 2 plus the line support member 3, but a height of the base member 2 plus the device placing portion 21 of the line support member 3. With this structure, the height may be reduced as compared to the height of the fixed rail (base member) plus the movable rail (line support member) with the conventional structure.

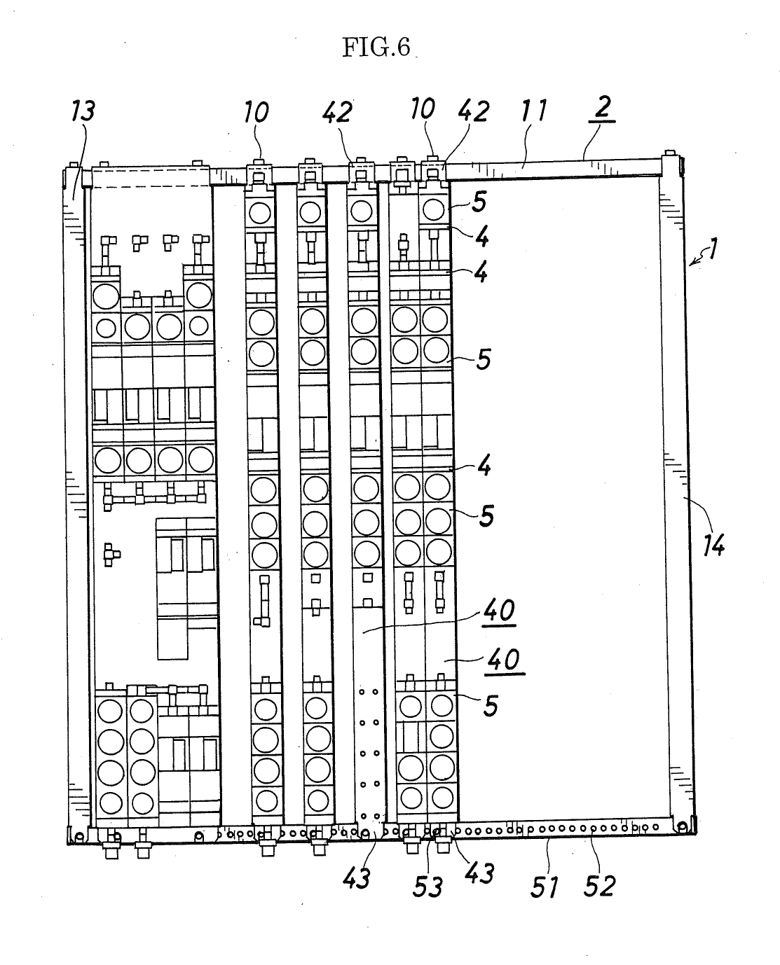

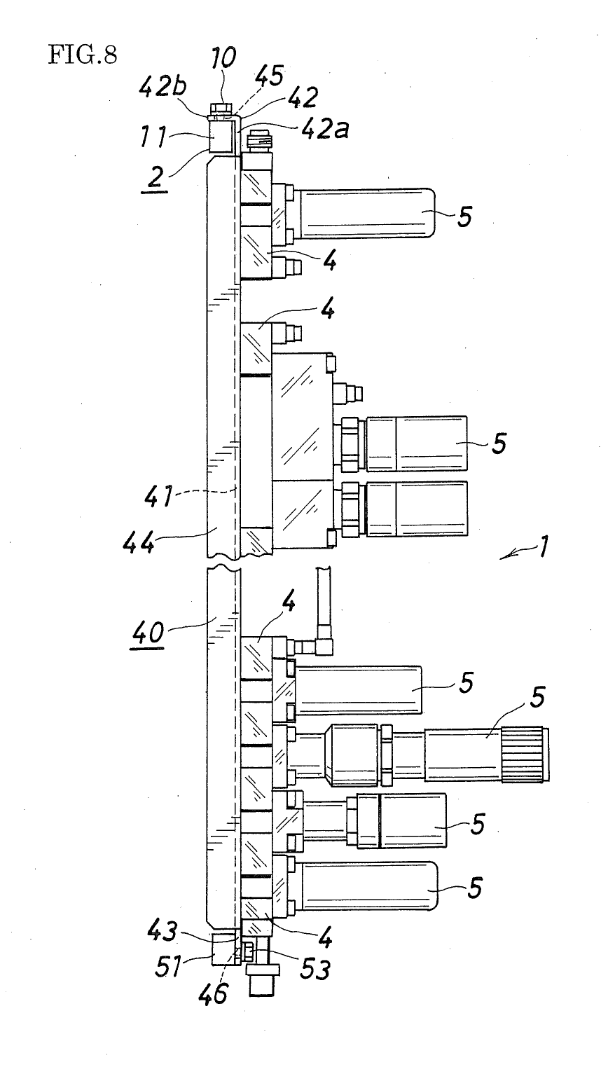

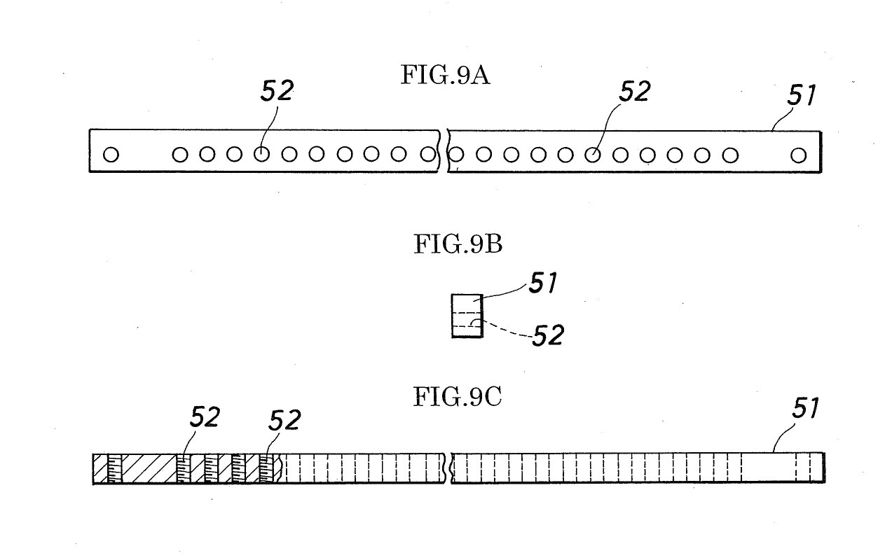

FIGS. 6 to 9 illustrate a fluid control apparatus according to a second embodiment of the present invention. The fluid control apparatus according to the second embodiment 1 differs from that of the first embodiment in structure of the line support member 40 and the second supporting frame member 51. In the following description, the same structures as those of the first embodiment will be designated by the same reference symbols and will not be described.

The line support member 40 according to the second embodiment is formed as an integrated part by folding sheet metal. As the common structure with the first embodiment, the line support member 40 is constituted by a flat-plate shaped device placing portion 41, upper and lower mounting portions 42 and 43 disposed at both ends of the device placing portion 41, and reinforcing portions 44 extending from both edges of the device placing portion 41. The device placing portion 41 is provided at required intervals with threaded holes 41a for mounting the joint members 4.

In this case, the upper mounting portion 42 of the line support member 40 is constituted, in the same manner as that of the first embodiment, by a flat-plate shaped flat-plate part 42a flush with the device placing portion 41, and a right-angled part 42b extending from the flat-plate part 42a at a right angle, thereby being approximately L shaped. The right-angled part 42b is provided with a through hole 45 penetrating through the right-angled part 42b vertically. The reinforcing portions 44 are formed not to fall upon the flat-plate part 42a of the mounting portion 42. The end faces of the reinforcing portions 44 and the right-angled part 42b of the upper mounting portion 42 are designed to sandwich the first supporting frame member 11.

The lower mounting portion 43 of the line support member 40, which is different from that of the first embodiment, is flat-plate shaped and flush with the device placing portion 41, which is flat-plate shaped. That is, the shape of the lower mounting portion 43 is the same as the lower mounting portion 23 of the first embodiment without the right-angled part 23b. The lower mounting portion 43 is provided with a through hole 46 penetrating through the lower mounting portion 43 in a front-rear direction (extending from the front side to the back side) and having an opening at the lower end.

To coincide with the above structure, the second supporting frame member 51 is provided with threaded holes 52 extending from the front side toward the back side of the second supporting frame member 51.

The right-angled part 42b of the upper mounting portion 42 of each of the line support member 40 is overlapped with an upper surface (outer surface) of the first supporting frame member 11 and a male-threaded member 10 is screwed into one of the threaded holes 15 of the first supporting frame member 11 through the through hole 45 of the upper mounting portion 42 from above (outer side) of the right-angled part 42b of the upper mounting portion 42 whereby the upper end of the line support member 40 is secured to the first supporting frame member 11, whereas the lower mounting portion 43 having a flat-plate shape is overlapped with an front surface (surface on the front side) of the second supporting frame member 51 and a male-threaded member 53 is screwed into the threaded hole 52 of the second supporting frame member 51 through the through hole 46 of the lower mounting portion 43 from the front side of the lower mounting portion 43 whereby the lower end of the line support member 40 is secured to the second supporting frame member 51.

With the fluid control apparatus 1 according to the second embodiment, in securing line support members 40, positioning of each of the line support members 40 only requires matching through holes 45 and 46 of the mounting portions 42 and 43 with threaded holes 15 and 52 of respective supporting frame members 11 and 51, which enables simple and easy securing work and shortened assembling time. Moreover, because the right-angled part 42b of the bent-shaped upper mounting portion 42 of each of the line support members 40 is overlapped with the outer surface of the first supporting frame member 11, the height of the base member 2 (each of the supporting frame members 11 and 51) plus the line support member 40 is not a height of the base member 2 plus the line support member 40, but a height of the base member 2 plus the device placing portion 41 of the line support member 40. With this structure, the height may be reduced as compared to the height of the fixed rail (base member) plus the movable rail (line support member) with the conventional structure.

Furthermore, according to the fluid control apparatus 1 of the second embodiment, because the upper mounting portion 42 differs from the lower mounting portion 43 in shape, incorrect mounting that the line support member is mounted upside down is prevented without fail.

In addition, according to the fluid control apparatus 1 of the second embodiment, the tightening directions of the male-threaded members 10 and 53 are a vertical direction on the upper mounting portion 42 side, and a front-rear direction on the lower mounting portion 43 side. In contrast, according to the first embodiment, the upper and lower mounting portions 22 and 23 are mounted with the male-threaded members that is tightened in an upper-lower direction. Because the upper and lower male-threaded members of the first embodiment are on the same axis and opposite with respect to the tightening direction, in the case where one of the male-threaded members 10 is tightened first and then the other of the male-threaded members 10 is tightened, there is a possibility that the tightening force (axial force) of the male-threaded member 10 tightened first may be decreased. According to the second embodiment, because the axes of the upper and lower male-threaded members 10 and 53 are on the different directions, the possibility of the above-mentioned decrease in the axial force may be eliminated.

Furthermore, with the fluid control apparatus 1 according to the second embodiment, the center of the position of the male-threaded member 10 fixed to the first supporting frame member 11 is designed not to align that of the male-threaded member 53 fixed to the second supporting frame member 51, which serves to prevent tilting in the Z direction (rotation of the line support member 40).

In the second embodiment, the through hole 46 formed in the lower mounting portion 43 may be circular hole that is not opened at the lower end. In the case where the through hole 46 is opened at the lower end, it is possible to install the fluid control apparatus 1 in the following order.

First, the male-threaded members 10 and 53 are temporarily screwed into the first supporting frame member 11 and the second supporting frame member 51. In this state, the through hole 46 in the lower mounting portion 43 of the line support member 40 is fitted with the male-threaded member 53 of the second supporting frame member 51. Next, the upper mounting portion 42 is overlapped with the outer surface of the first supporting frame member 11, and the line support member 40 is positioned and temporarily secured by means of the male-threaded member 10 fitted in advance, and then the first supporting frame member 11 and the second supporting frame member 51 in this order are secured by further tightening the male-threaded members 10 and 53.

In this case, in the second embodiment where the lower mounting portion 43 cannot be fitted with the second supporting frame member 51, the positioning is facilitated by fitting the through hole 46 with the male-threaded member 53.

In the case of mounting the line support member 40 with the “upper” and “lower” of FIG. 6 being as the above and below, respectively, in the state where the supporting frame members 11 and 12 are placed horizontally, the right-angled part 42b of the upper mounting portion 42 is overlapped with the outer surface of the first supporting frame member 11, thereby preventing disengagement (falling) of the line support member 40. Therefore, the structure that the lower mounting portion 43 is not provided with the right-angled part does not result in increase in assembling time. But, in the case where the line support member 40 is to be mounted with the “upper” and “lower” of FIG. 6 being as the right and left sides (in the state where the supporting frame members 11 and 51 are placed vertically), disengagement downward (falling) of the lower mounting portion 43 in securing the upper mounting portion 42 to the first supporting frame member 11 results in difficult securing work. In the case where the through hole 46 of the lower mounting portion 43 is fitted with the male-threaded member 53 as mentioned above, even if the supporting frame members 11 and 51 are place vertically, mounting the line support members 40 may be simply and easily accomplished, which offers greater versatility with respect to the installation location and installation method of the fluid control apparatus 1.

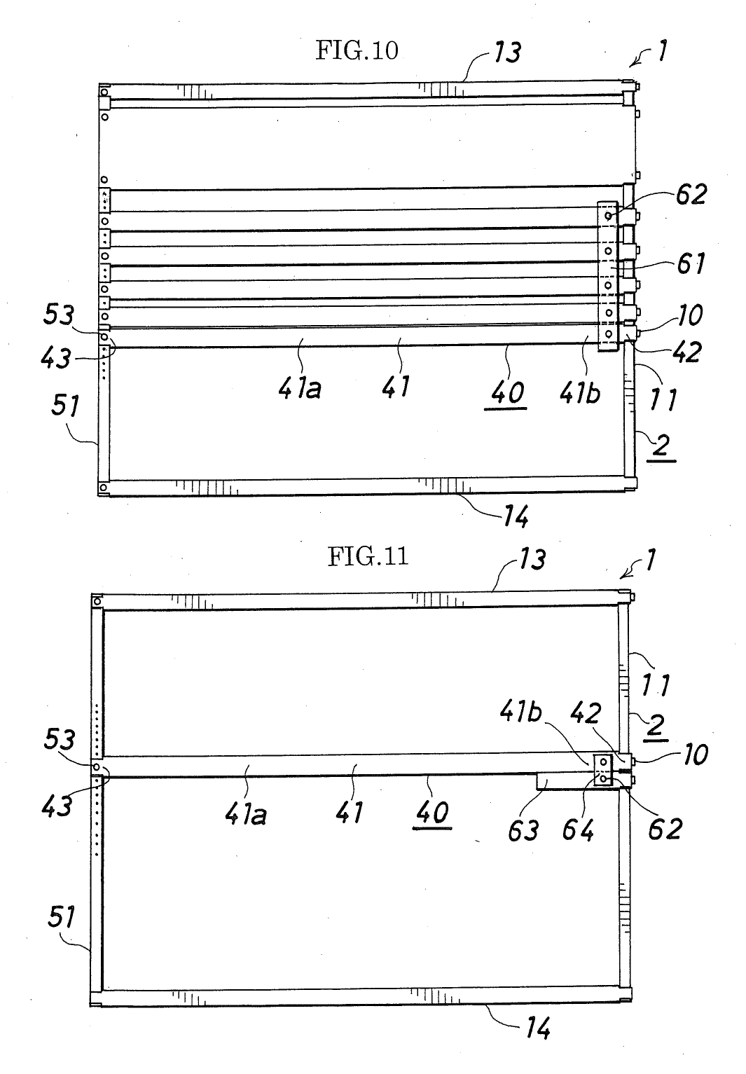

In the case where the line support member 40 is to be mounted with the supporting frame members 11 and 51 being placed vertically, there is a possibility that the line support member 40 can be tilted due to the force of its own weight including the joint members 4 and the fluid control devices 5 because only one male-threaded member 10 or 53 is used for mounting each of the first and second supporting frame member 11 and 51. To prevent this tilting, for example, as illustrated in FIG. 10, adjacent line support members 40 may be connected by means of a connecting member 61. In this case, the connecting member 61 is made of, for example, stainless steel plate material and is mounted to each of the line support members 40 by bolts 62. The device placing portion 41 of the line support member 40 is provided with a connecting member placing surface 41b as an extending portion from a fluid control device placing surface 41a, and the connecting member 61 is mounted using the connecting member placing surface 41b.

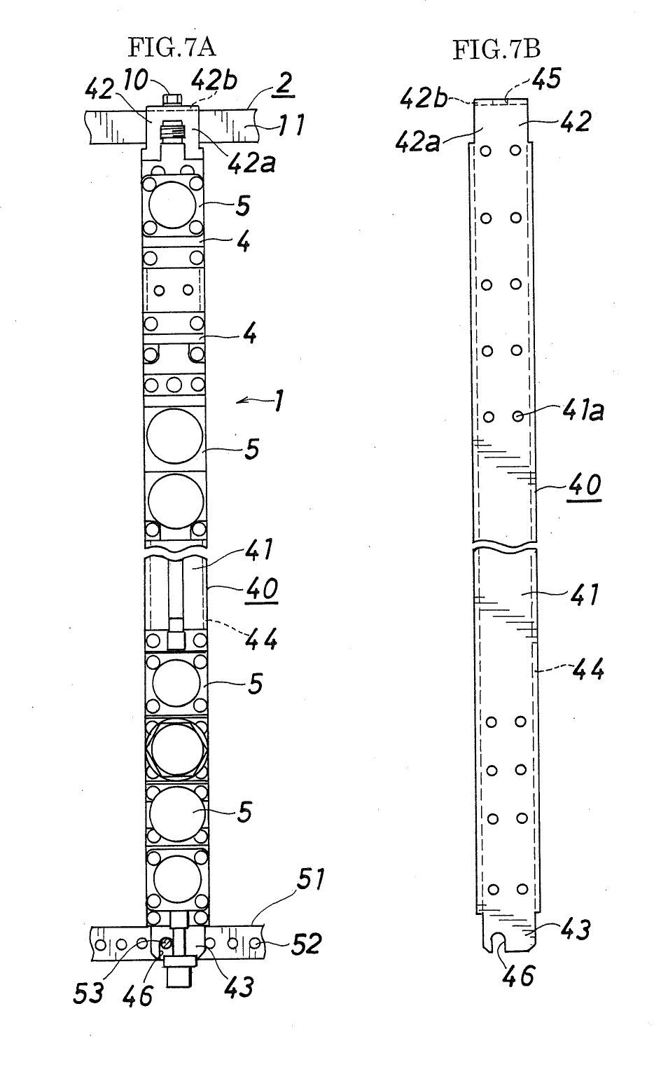

In the case where there exists no adjacent line support member 40, as illustrated in FIG. 11, a dummy member 63 may be used to secure the dummy member 63 to the second supporting frame member 51, and this dummy member 63 and the line support member 40 may be connected by a connecting member 64. In FIG. 11, the dummy member 63 is secured to the second supporting frame member 51, but may be secured to the first supporting frame member 11. As the dummy member, the line support member 40 (FIG. 7B) to which no joint members 4 and fluid control devices 5 are assembled may be used.

What is claimed is:

1. A fluid control apparatus having a plurality of lines, each of the lines constituted by a plurality of fluid control devices mounted to a line support member, the line support members parallel to one another being detachably mounted to a base member,
wherein the base member, having a rectangular frame-like shape, is constituted by a first supporting frame member, a second supporting frame member parallel to the first supporting frame member, a first connecting frame member orthogonal to the first and second supporting frame members, and a second connecting frame member orthogonal to the first and second supporting frame members; each of the frame members being provided with threaded holes at required intervals depending on each frame member; each of the line support members including a flat-plate shaped device placing portion, and first and second mounting portions provided at both ends of the device placing portion; each of the first and second mounting portions having a through hole; the first mounting portion being bent-shaped; the threaded holes of the first supporting frame member being oriented in a direction from an outer surface of the first supporting frame member toward an inner surface thereof; and each of the line support members being secured to the first supporting frame member such that the first mounting portion is overlapped with the outer surface of the first supporting frame member and a male-threaded member is screwed into one of the threaded holes of the first supporting frame member from an outer side of the first mounting portion.

2. The fluid control apparatus according to claim 1, wherein the second mounting portion is bent-shaped, the threaded holes of the second supporting frame member are oriented in a direction from an outer surface of the second supporting frame member toward an inner surface thereof, and each of the line support members is secured to the second supporting frame member such that the second mounting portion is overlapped with the outer surface of the second supporting frame member and a male-threaded member is screwed into one of the threaded holes of the second supporting frame member corresponding to the screwed threaded hole of the first supporting frame member from an outer side of the second mounting portion.

3. The fluid control apparatus according to claim 1, wherein the second mounting portion is flat-plate shaped and flush with the device placing portion, the threaded holes of the second supporting frame member are oriented in a direction from a front side of the second supporting frame member toward a back side thereof, and each of the line support members is secured to the second supporting frame member such that the second mounting portion is overlapped with the front side of the second supporting frame member and a male-threaded member is screwed into one of the threaded holes of the second supporting frame member corresponding to the screwed threaded hole of the first supporting frame member from a front side of the second mounting portion.

4. The fluid control apparatus according to claim 3, wherein the through hole of the second mounting portion is opened at an end face thereof.

5. The fluid control apparatus according to claim 4, wherein in a state where the fluid control apparatus is installed with the base member disposed vertically, the first supporting frame member is placed at either one side of right and left sides, the second supporting frame member is placed at the other side, the line support members are arranged in horizontally parallel to one another, and the male-threaded member is temporarily screwed into the second supporting frame member, the opened through hole of the second mounting portion is designed to be fitted with the male-threaded member.

6. The fluid control apparatus according to claim 5, wherein adjacent line support members arranged one above the other are connected by a connecting member.

7. The fluid control apparatus according to claim 5, wherein at least one of the line support members, on a lower side thereof, is adjacent to a dummy member mounted to at least one of the supporting frame members, and the line support member and the dummy member are connected by a connecting member.
